(19) United States
(12) Patent Application Publication
(10) Pub. No.: US 2026/0244130 A1
(43) Pub. Date: Aug. 20, 2026

(54) FIXING DEVICE AND IMAGE FORMING APPARATUS

(71) Applicant: KYOCERA Document Solutions Inc., Osaka (JP)

(72) Inventors: Tomoyasu YAMADA, Osaka (JP); Yuhiro SAKAI, Osaka (JP)

(73) Assignee: KYOCERA Document Solutions Inc., Osaka (JP)

(21) Appl. No.: 19/531,726

(22) Filed: Feb. 6, 2026

(30) Foreign Application Priority Data
Feb. 19, 2025 (JP) 2025-024905

(51) Int. Cl. G03G 15/20

(52) U.S. Cl. CPC G03G 15/2028; G03G 15/2064; G03G 2215/2035

(57) ABSTRACT

A fixing deviceincludes a cylindrical fixing belt, a heater, a pressure roller, a pair of holding members, and a separation guide. The cylindrical fixing belt has flexibility and is rotatably supported. The heater heats the fixing belt. The pressure member is rotatably supported and faces the heater across the fixing belt to form a pressurized region for heating and pressurizing toner on a sheet between the fixing belt and the pressure member. The pair of holding members hold both end portions of the fixing belt. The separation guide separates the sheet passed through the pressurized region from the fixing belt. The separation guide is positioned with respect to the pair of holding members such that its tip faces the fixing belt at a predetermined interval and is supported movably in a direction away from the fixing belt.

### INCORPORATION BY REFERENCE

This application is based on and claims the benefit of priority from Japanese patent application No. 2025-024905 filed on Feb. 19, 2025, which is incorporated by reference in its entirety.

### BACKGROUND

The present disclosure relates to a fixing device including a separation guide, and an image forming apparatus including the fixing device.

A medium on which an image is formed in the image forming apparatus includes a plain paper, a thick paper, a thin paper, a glossy sheet, a resin sheet, an envelope, and the like. In a fixing device for fixing toner image to such a various media, it is necessary to reduce the occurrence of problems in which the medium passing through a pressurized region is wound around a fixing member. As a countermeasure, a separation member may be provided to prevent the medium from being wound around the fixing member.

The fixing device may include holding members for holding the end portions of the fixing belt, and the holding member may have the first protruding portion protruding inward and the second protruding portion protruding further inward from the first protruding portion and facing the separating member. In this fixing device, when a paper jam occurs in the separation nip (corresponding to the pressurized region), after the separation member is pulled by the sheet to be removed, the positioning portion of the separation member abuts not on the fixing belt but the second protruding portion, so that the impact on the fixing belt is reduced.

### SUMMARY

A fixing device according to the present disclosure includes a cylindrical fixing belt, a heater, a pressure roller, a pair of holding members, and a separation guide. The cylindrical fixing belt has flexibility and is rotatably supported. The heater heats the fixing belt. The pressure member is rotatably supported and faces the heater across the fixing belt to form a pressurized region for heating and pressurizing toner on a sheet between the fixing belt and the pressure member. The pair of holding members hold both end portions of the fixing belt. The separation guide separates the sheet passed through the pressurized region from the fixing belt. The separation guide is positioned with respect to the pair of holding members such that its tip faces the fixing belt at a predetermined interval and is supported movably in a direction away from the fixing belt.

An image forming apparatus according to the present disclosure includes an image forming part and the fixing device. The image forming part forms a toner image on a sheet. The fixing device fixes the toner image formed in the image forming unit to the sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a side view schematically showing an internal structure of an image forming apparatus according to one embodiment of the present disclosure.

FIG. 2 is a perspective view showing a fixing device according to the embodiment of the present disclosure.

FIG. 3 is a perspective view showing a part of the fixing device according to the embodiment of the present disclosure.

FIG. 4 is a cross-sectional view taken along the line I-I of FIG. 2.

FIG. 5 is a cross-sectional view taken along the line II-II of FIG. 2.

FIG. 6 is a perspective view showing a holding member of the fixing device according to the embodiment of the present disclosure.

FIG. 7 is a perspective view showing a fixing housing and a separation guide of the fixing device according to the embodiment of the present disclosure.

FIG. 8 is a perspective view showing an opening of the fixing housing and a hook of the separation guide in the fixing device according to the embodiment of the present disclosure.

### DETAILED DESCRIPTION

Hereinafter, with reference to the drawings, an image forming apparatus and a fixing device according to one embodiment of the present disclosure will be described.

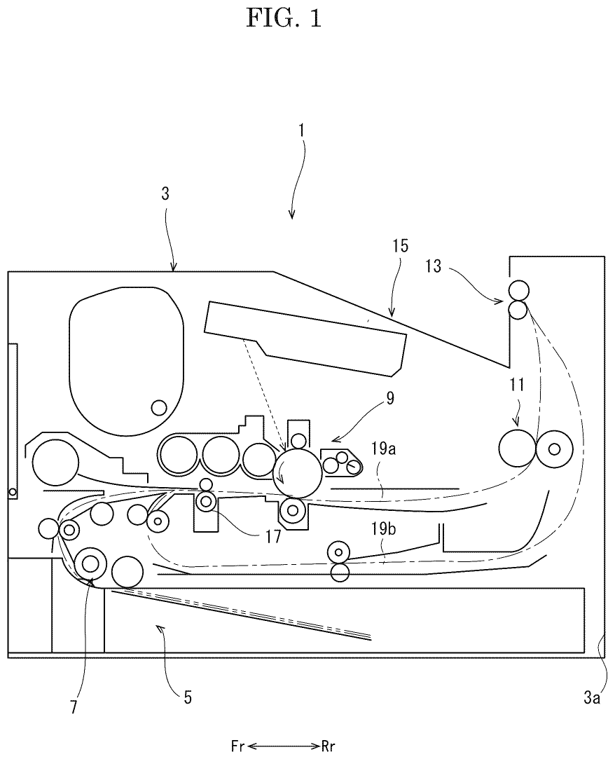

First, with reference to FIG. 1, the image forming apparatus 1 will be described. FIG. 1 is a front view schematically showing the internal structure of the image forming apparatus 1. Reference numerals Fr, Rr, L, R, Up, and Lo attached to the following drawings indicate the front, rear, left, right, upper, and lower, respectively.

An apparatus main body 3 of the image forming apparatus 1 includes a sheet feeding cassette 5 in which a sheet is stored, a sheet feeding device 7 which feeds the sheet from the sheet feeding cassette 5, an image forming part 9 which forms a toner image on the sheet by an electrophotographic method, a fixing device 11 which fixes the toner image to the sheet, a discharge device 13 which discharges the sheet, and a discharge tray 15 on which the discharged sheet is stacked. A pair of registration rollers 17 is disposed between the sheet feeding device 7 and the image forming part 9.

The sheet feeding cassette 5 is accommodated in a cassette storage space 3a provided in the lower portion of the inside of the apparatus main body 3. The sheet feeding device 7 is disposed above the front end portion of the cassette storage space 3a. The pair of registration rollers 17 is disposed above the sheet feeding device 7. The image forming part 9 is disposed on the rear side of the pair of registration rollers 17. The fixing device 11 is disposed on the rear side of the image forming part 9. The discharge device 13 is disposed above the fixing device 11. The discharge tray 15 is provided on the upper surface of the apparatus main body 3.

Further, a main conveying path 19a and a double-sided conveying path 19b along which the sheet is conveyed are formed in the apparatus main body 3. The main conveying path 19a is formed along a conveying direction from the sheet feeding device 7 to the discharge device 13 via the image forming part 9 and the fixing device 11. In the following description, the upstream side and the downstream side indicate the upstream side and the downstream side in the conveying direction X. The double-sided conveying path 19b branches from the main conveying path 19a on the downstream side of the fixing device 11 and merges with the main conveying path 19a on the upstream side of the pair of registration rollers 17.

Next, the image forming operation will be briefly described. In the case of single-sided printing, the sheet fed from the sheet feeding cassette 5 by the sheet feeding device 7 is conveyed along the main conveying path 19a, the skew of the sheet is corrected by the pair of registration rollers 17, and the sheet is conveyed to the image forming part 9. In the image forming part 9, the toner image is formed on the sheet. The sheet on which the toner image is formed is conveyed to the fixing device 11 along the main conveying path 19a, and the toner image is fixed to the sheet in the fixing device 11. The sheet on which the toner image is fixed is discharged to the discharge tray 15 by the discharge device 13.

In the case of doble-sided printing, the sheet on which the toner image is fixed to one side of the sheet by the fixing device 11 passes through the fixing device 11 and is switched back to be conveyed to the double-sided conveying path 19b. The sheet is conveyed along the main conveying path 19a via the double-sided conveying path 19b. After the skew of the sheet is corrected by the pair of registration rollers 17, the toner image is formed to the other surface of the sheet by the image forming part 9. The sheet on which the toner image is formed is conveyed to the fixing device 11 along the main conveying path 19a, and the toner image is fixed to the other surface of the sheet in the fixing device 11. The sheet on which the toner image is fixed is conveyed along the main conveying path 19a to the discharge device 13, and discharged to the discharge tray 15 by the discharge device 13.

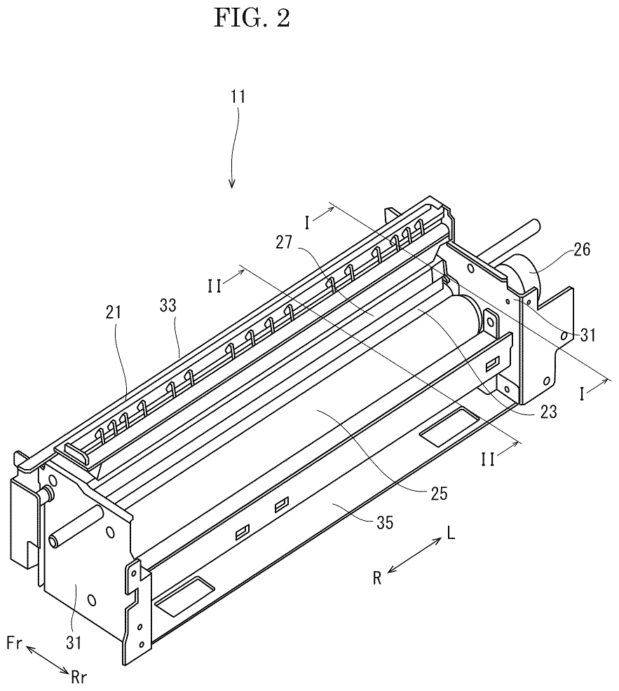

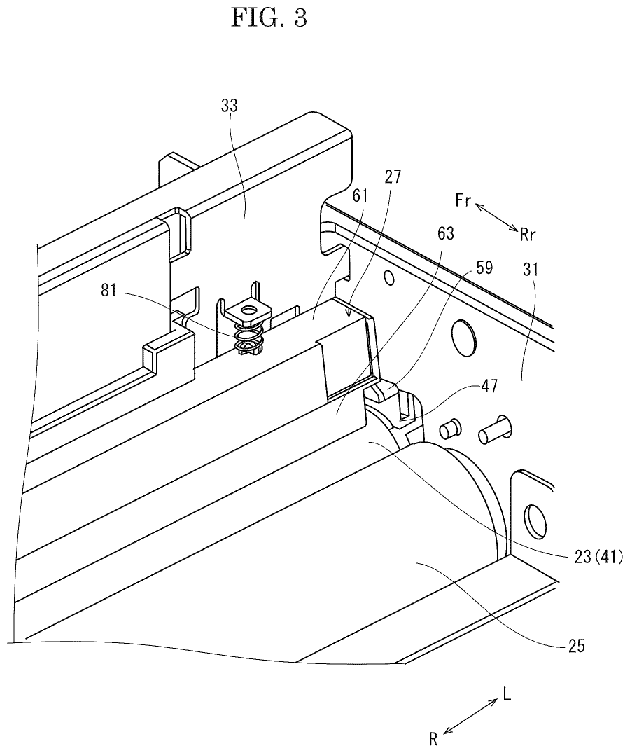

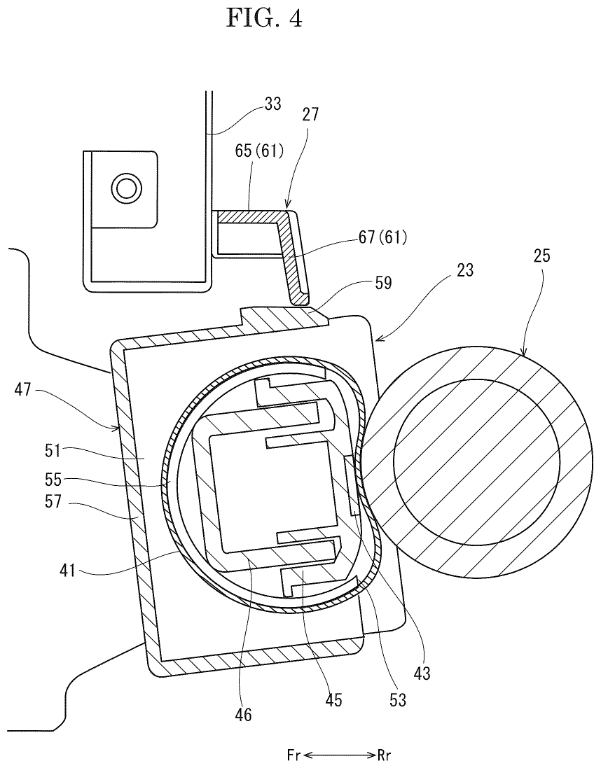

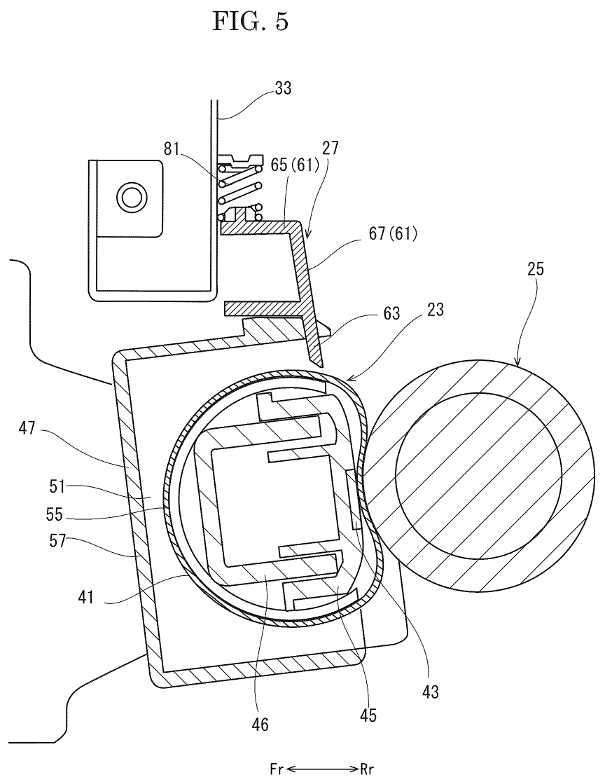

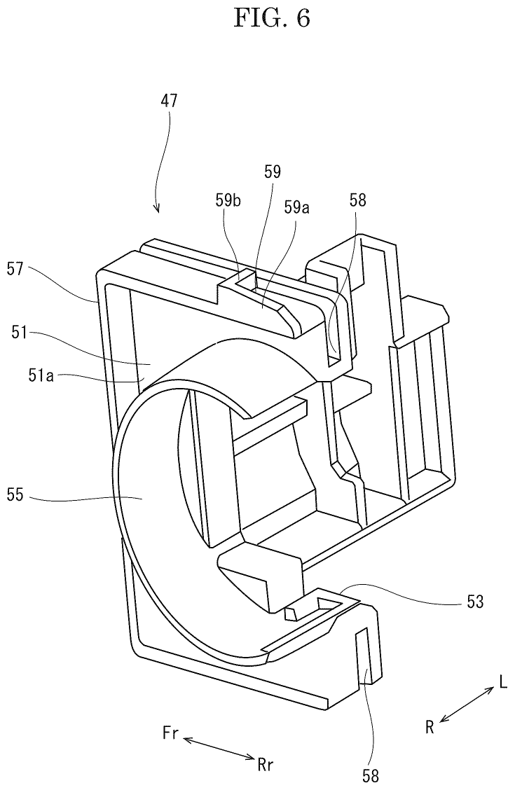

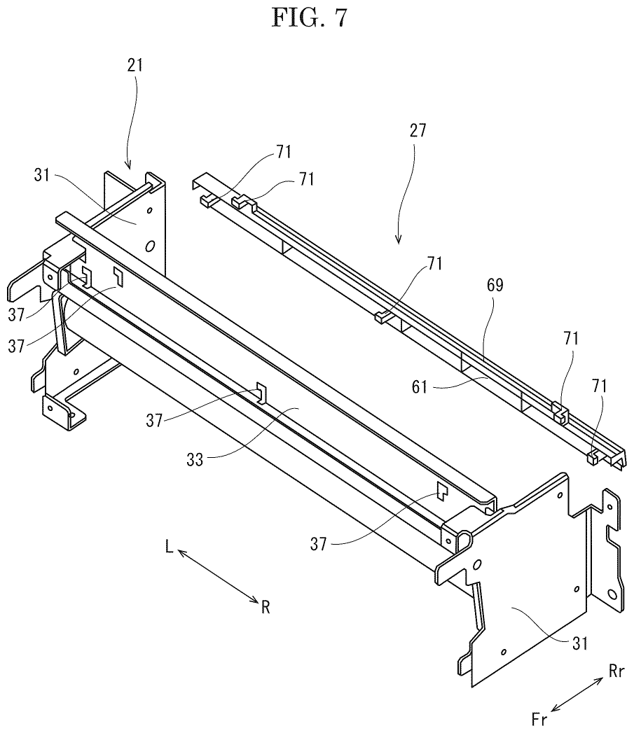

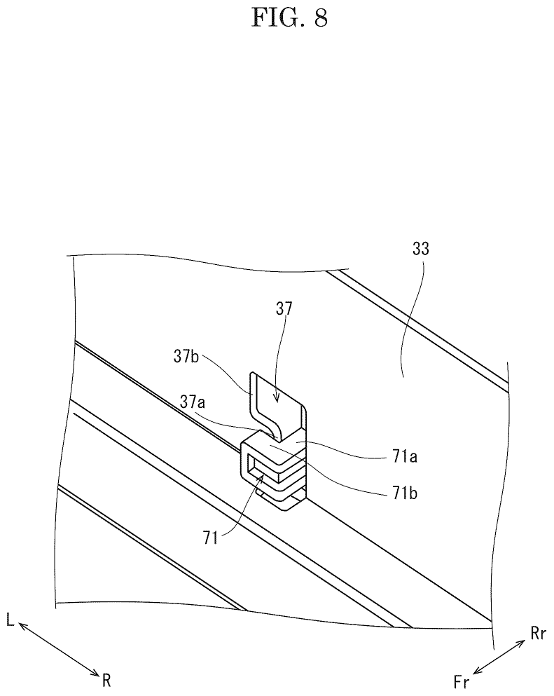

Next, the fixing device 11 will be described with reference to FIGS. 2 to 7. FIG. 2 and FIG. 3 are perspective views showing the fixing device, FIG. 4 and FIG. 5 are cross-sectional views showing the fixing device, FIG. 6 is a perspective view showing a holding member, and FIG. 7 and FIG. 8 are perspective views showing a fixing housing and a separation guide. The fixing device 11 includes a fixing housing 21, a belt assembly 23, a pressure roller 25, and a separation guide 27.

First, the fixing housing 21 will be described. As shown in FIG. 2 and FIG. 7, the fixing housing 21 includes left and right side plates 31 facing each other in the left-and-right direction, and a front plate 33 and a lower plate 35 disposed between the left and right side plates 31. The fixing housing 21 is made of sheet metal. In the left and right side plates 31, cutouts (not shown) extending rearward from the front edges are formed for supporting the belt assembly 23.

As shown in FIG. 7, the front plate 33 has five openings 37 (only four openings are shown in FIG. 7). The five openings 37 include three openings formed at predetermined intervals in the width direction along the lower row and two openings formed at both end portions in the width direction along the upper row. As shown in FIG. 8, the opening 37 is L-shaped, and has a vertical portion 37a extending in the vertical direction and a horizontal portion 37b bending leftward or rightward from the upper end of the vertical portion 37a. In this example, the right two openings 37 are formed such that the horizontal portions 37b are bent rightward from the upper ends of the vertical portions 37a, and the other openings 37 are formed such that the horizontal portions 37b are bent leftward from the upper ends of the vertical portions 37a.

Next, the belt assembly 23 will be described. As shown in FIG. 4 and FIG. 5, the belt assembly 23 includes a fixing belt 41, a heater 43 for heating the fixing belt 41, a heater holder 45 for housing the heater 43, and left and right holding members 47 for holding the heater holder 45.

First, the fixing belt 41 will be described. The fixing belt 41 is formed in a cylindrical shape having a predetermined inner diameter and a width longer than the width of the sheet. The fixing belt 41 is made of flexible material, and includes a base material layer, an elastic layer provided on the outer peripheral surface of the base material layer, and a release layer provided on the outer peripheral surface of the elastic layer. The base material layer is made of resin. The elastic layer is made of silicone rubber or the like. The release layer is made of a PFA tube or the like.

Next, the heater 43 will be described. The heater 43 is a rectangular planar heater 43. The planar heater 43 includes a base material, a heat insulating layer, a heating resistor layer, and a coat layer. When the heating resistor layer is energized, the heating resistor layer generates heat.

Next, the heater holder 45 will be described. The heater holder 45 is formed in a substantially semi-cylindrical shape along the circumferential direction of the inner circumferential surface of the fixing belt 41, and has a width wider than that of the fixing belt 41. A flat surface is formed on the top of the outer peripheral surface of the heater holder 45. A recess for housing the planar heater 43 is formed on the flat surface. The heater holder 45 is made of heat-resistant resin such as liquid crystal polymer. The heater holder 45 is supported by a stay 46.

Next, the left and right holding members 47 will be described with reference to FIG. 6. FIG. 6 is a perspective view showing the left holding member 47. Here, the left holding member 47 will be described. The right holding member 47 has the same function as the left holding member.

The holding member 47 has a substantially rectangular regulating portion 51. One surface 51a (right surface) of the regulating portion 51 is formed flat and serves as a regulating surface for regulating movement of the fixing belt 41 in the width direction. The regulating portion 51 is formed with an opening 53 having a substantially ¾ circular arc shape opened on the rear side. A shaft support portion 55 is erected on the regulating surface 51a along the periphery of the opening 53. That is, the shaft support portion 55 is formed in a substantially cylindrical shape having a substantially C-shaped cross-section opened on the rear side. The axial direction of the shaft support portion 55 is perpendicular to the regulating surface 51a. An insulating wall 57 is erected on the regulating surface 51a along the upper edge, the lower edge, and the front edge. On the upper and lower outer surfaces of the regulating portion 51, engaging grooves 58 extending a direction along the regulating surface (the front-and-rear direction) are formed outside (on the left side of) the regulating surface 51a in the axial direction.

On the substantially rear half portion of the upper surface of the insulating wall 57 erected along the upper edge of the regulating surface 51a, a positioning portion 59 protruding upward is formed. The positioning portion 59 has an L-shape when viewed from above, and includes an edge portion 59a along the front edge of the insulating wall 57 and a central portion 59b along the axial direction of the shaft support portion 55. The edge portion 59a and the central portion 59b have the same height. The edge portion 59a is formed with a curved shape that gradually decreases in height toward the end of the insulating wall 57 (rearward). The holding member 47 is made of resin having heat resistance and abrasion resistance.

The right and left end portions of the fixing belt 41 are inserted around the shaft support portions 55 of the right and left holding members 47. The shaft support portions 55 hold the fixing belt 41 in a substantially cylindrical shape, and guide the fixing belt 41 rotatably along the circumferential direction (rotational direction). The heater holder 45 and the stay 46 are inserted into the hollow space of the fixing belt 41 with the heater 43 facing the opening 53 of the regulating portion 51 of the holding member 47 (see FIG. 4 and FIG. 5). The left and right end portions of the heater holder 45 and the stay 46 are supported by the left and right holding members 47 through the openings 53 of left and right holding members 47.

The left and right holding members 47 are attached to the left and right side plates 31 below and on the rear side of the openings 37 (see FIG. 7) formed in the front plate 33 of the fixing housing 21. More specifically, the holding member 47 is attached to the side plate 31 by fitting the edges of the cutout formed in the side plate 31 into the engaging grooves 58 formed in the regulating portion 51. The holding members 47 are biased rearward (in the direction close to the pressure roller 25 described later) by a biasing member (not shown).

Next, the pressure roller 25 will be described. The pressure roller 25 has a rotational shaft, an elastic layer provided on the outer peripheral surface of the rotational shaft, and a release layer provided on the outer peripheral surface of the elastic layer.

Both end portions of the rotational shaft of the pressure roller 25 are rotatably supported by the left and right side plates 31 of the fixing housing 21 on the rear side of the belt assembly 23. The pressure roller 25 faces the heater 43 across the fixing belt 41 of the belt assembly 23, and forms a pressurized region between the pressure roller 25 and the fixing belt 41. In this example, the pressurized region is formed substantially along the vertical direction. As described above, the holding members 47 for holding the fixing belt 41 are pressed toward the pressure roller 25 by the biasing members. Movement of the holding member 47 in the axial direction is restricted by the side plate 31 of the fixing housing 21, but movement of the holding member 47 in the direction along the engaging groove 58 (a separation/contact direction with respect to the pressure roller 25, the front-and-rear direction) is permitted. Therefore, the position of the holding member 47 with respect to the pressure roller 25 in the separation/contact direction is varied by switching the pressing force of the biasing members.

As shown in FIG. 2, a drive gear 26 is fixed to one end of the rotational shaft of the pressure roller 25. The drive gear 26 is connected to a motor (not shown) via a gear train (not shown). When the motor is driven to rotate the pressure roller 25 in the clockwise direction in FIG. 4 and FIG. 5, the fixing belt 41 travels in the counterclockwise direction in FIG. 4 and FIG. 5. As a result, the sheet on which the toner image is formed in the image forming part 9 passes through the pressurized region from the lower to the upper. The pressure roller 25 is an example of the pressure member according to the present disclosure.

Next, the separation guide 27 will be described with reference to FIG. 3, FIG. 4, FIG. 5 and FIG. 7. As shown in FIG. 4 and FIG. 5, the separation guide 27 has a support part 61 and a guide part 63. The support part 61 has a length equal to the length of the fixing belt 41 in the width direction, and has an upper plate 65 and a rear plate 67 crossing at an angle slightly wider than a right angle. As shown in FIG. 7, a vertical wall 69 is erected on the upper surface of the upper plate 65 in the width direction. Both the end portions of the upper plate 65 are bent downward at substantially right angles. A rib along the width direction and a rib along the height direction are provided in the space between the upper plate 65 and the rear plate 67. The guide part 63 is formed in a plate shape, and as shown in FIG. 5, is formed continuously to the rear plate 67 of the support part 61. The tip (lower end) of the guide part 63 is tapered. The guide part 63 has a shorter length than the support part 61. That is, both the end portions of the support part 61 project outward from the guide part 63.

As shown in FIG. 7, five hooks 71 are formed on the rear surfaces of the rear plate 67 and the vertical wall 69 of the support part 61. The five hooks 71 include three hooks formed at predetermined intervals in the width direction on the rear surface of the rear plate 67, and two hooks formed on both the end portion of the rear surface of the vertical wall 69 in the width direction. As shown in FIG. 8, the hook 71 is L-shaped when viewed from above, and has a base portion 71a extending forward and a tip portion 71b bent leftward or rightward from the tip of the base portion 71a. In this example, the right two hooks 71 are formed such that their tip portions 71b bent rightward from the tip of the base portions 71a, and the other two hooks 71 are formed such that their tip portions 71b bent leftward from the tip of the base portions 71a.

The separation guide 27 is supported by the front plate 33 of the fixing housing 21. As shown in FIG. 7 and FIG. 8, the five hooks 71 of the separation guide 27 are inserted into the five openings 37 of the front plate 33. More specifically, as shown in FIG. 7, the hook 71 is engaged with the front plate 33 by inserting the tip portion 71b of the hook 71 into the horizontal portion 37b of the opening 37 and then moving the base portion 71a of the hook 71 downward along the vertical portion 37a of the opening 37.

Further, as shown in FIG. 3 and FIG. 5, the separation guide 27 is biased downward with respect to the front plate 33 by a coil spring 81 (biasing member). As a result, as shown in FIG. 3 and FIG. 4, both the end portions of the support part 61 of the separation guide 27 abut against the positioning portions 59 of the left and right holding members 47 of the belt assembly 23. Further, as shown in FIG. 5, the guide part 63 of the separation guide 27 faces the surface of the fixing belt 41 at a predetermined interval from an opposite direction to the rotation direction of the fixing belt 41 on the downstream side of the pressurized region in the rotation direction of the fixing belt 41. The tip of the guide part 63 of the separation guide 27 faces the vicinity of the end portion of the shaft support portion 55 of the holding member 47.

The fixing operation of the fixing device 11 having the above configuration will be described. When the motor is driven, the pressure roller 25 is rotated through the gear train and the drive gear 26, and the fixing belt 41 follows the pressure roller 25 and travels in the direction opposite to the rotation direction of the pressure roller 25. The heater 43 is driven to heat the fixing belt 41. When the sheet on which the toner image is formed by the image forming part 9 is conveyed to the pressurized region, it passes through the pressurized region from the lower to the upper. At this time, the toner image is heated and fixed to the sheet.

When the sheet passing through the pressurized region is wound around the fixing belt 41, the leading portion of the sheet is caught by the guide part 63 of the separation guide 27 and pulled away from the fixing belt 41. The separated sheet is conveyed to the discharge device 13 along the main conveying path 19a. In general, when the toner image fixed on the sheet is in contact with the fixing belt 41, the sheet is wound around the fixing belt 41 in many cases. On the other hand, since the toner image is not fixed to the leading end portion of the sheet, it is difficult to be in contact with the fixing belt 41. As a result, although there is a space between the tip of the separation guide 27 and the fixing belt 41, the leading end portion of the sheet is not in contact with the fixing belt 41 and can be separated from the fixing belt 41 by the separation guide 27.

When removing the sheet jammed in the pressurized region, the separation guide 27 is moved upward (away from the fixing belt 41) against the biasing force of the coil spring 81, thereby increasing the interval between the guide part 63 of the separation guide 27 and the fixing belt 41. Through this interval, the sheet can be easily removed without applying a load to the fixing belt 41.

As described above, according to the present disclosure, by positioning the separation guide 27 with respect to the left and right holding members 47, the separation guide 27 can be accurately positioned with respect to the fixing belt 41. In particular, the separation guide 27 can be positioned such that a predetermined interval can be formed between the tip of the guide part 63 and the fixing belt 41. Since the separation guide 27 can be positioned without contacting with the fixing belt 41, damage and wear of the fixing belt 41 can be suppressed, and separation performance can be maintained.

Since the separation guide 27 is biased by the coil spring 81 and abuts on the positioning portions 59 of the holding members 47, it can be always kept in a constant posture with respect to the holding members 47. Further, since the separation guide 27 moves in a direction away from the fixing belt 41 during the sheet jam treatment, the jammed sheet can be easily removed.

Further, since the separation guide 27 is supported by the fixing housing 21 at a plurality of positions in the width direction, a warping of the separation guide 27 is suppressed, and the interval between the fixing belt 41 and the separation guide 27 can be appropriately maintained.

The separation guide 27 can be positioned with respect to the fixing housing 21 by bringing the hooks 71 provided on the separation guide 27 into contact with the lower end surfaces of the openings 37 of the front plate 33 of the fixing housing 21. However, in this case, depending on the assembling accuracy of the fixing housing 21 and the assembling accuracy of the belt assembly 23 (the left and right holding members 47) to the fixing housing 21, the positional relationship between the separation guide 27 and the fixing belt 41 which are positioned individually with respect to the fixing housing 21 may not be appropriate. In this embodiment, since the separation guide 27 is positioned relative to the right and left holding members 47 for holding the fixing belt 41, the separation guide 27 can be accurately positioned with respect to the fixing belt 41.

It is also conceivable that the pressing force of the fixing belt 41 (the holding member 47) against the pressure roller 25 is switched to an appropriate value by switching the biasing member of the fixing belt 41 (the holding member) depending on the medium on which the image is to be formed, such as a plain paper, a thick paper, a thin paper, a glossy sheet, a resin sheet, an envelope, and the like. In this case, the position of the holding members 47 in the separation/contact direction with respect to the pressure roller 25 varies with respect to the side plates 31 of the fixing housing 21 depending on the magnitude of the pressing force of the biasing member. The position of the fixing belt 41 also varies following it, and the position where the tip of the separation guide 27 faces the peripheral surface of the fixing belt 41 varies. However, since the positioning portions 59 is formed with a curved shape that gradually decreases in height toward the end of the insulating wall 57, the position of the separation guide 27 with respect to the fixing belt 41 in the separation/contact direction is adjusted in conjunction with the position of the holding members 47. Therefore, the interval between the tip of the separation guide 27 and the peripheral surface of the fixing belt 41 can always be maintained at an appropriate interval.

Although the disclosure has been described with respect to certain embodiments, the disclosure is not limited to the foregoing embodiments. The above embodiments can be modified by those skilled in the art without departing from the scope and spirit of the disclosure.

What is claimed is:

1. A fixing device comprising:
a cylindrical fixing belt which has flexibility and is rotatably supported;
a heater which heats the fixing belt;
a pressure member which is rotatably supported and faces the heater across the fixing belt to form a pressurized region for heating and pressurizing toner on a sheet between the fixing belt and the pressure member;
a pair of holding members which hold both end portions of the fixing belt; and
a separation guide which separates the sheet passed through the pressurized region from the fixing belt, wherein
the separation guide is positioned with respect to the pair of holding members such that its tip faces the fixing belt at a predetermined interval and is supported movably in a direction away from the fixing belt.

2. The fixing device according to claim 1, wherein
each of the pair of holding members includes:
a shaft support portion which rotatably supports one end portion of the fixing belt;
a restricting portion which restricts movement of the fixing member in a width direction by contacting with one end surface of the fixing belt; and
a positioning portion on which the separation guide abuts.

3. The fixing device according to claim 2, further comprising:
a fixing housing by which the pair of holding members are supported; and
a biasing member which is provided in the fixing housing and biases the separation guide so as to abut on the positioning portions of the pair of holding members.

4. The fixing device according to claim 3, wherein
the pair of holding members are supported by the fixing housing movably in a direction close to or away from the pressure member, and
the positioning portion is formed so as to decrease in height along the direction close to the pressure member.

5. The fixing device according to claim 3, wherein
the separation guide has a plurality of hooks arranged at predetermined intervals in the width direction,
the fixing housing has openings extending along a direction away from the fixing belt and into which the hooks are engageable, and
the hook is brought into contact with an end surface of the opening in the direction away from the fixing belt, thereby restricting movement of the separation guide in a direction away from the fixing belt.

6. An image forming apparatus comprising:
an image forming part which forms a toner image on a sheet, and
the fixing device according to claim 1, which fixes the toner image formed in the image forming part to the sheet.
